(19) United States
(12) Patent Application Publication
(10) Pub. No.: US 2026/0212404 A1
(43) Pub. Date: Jul. 23, 2026

(54) ORDERING SYSTEM AND METHOD

(71) Applicant: TARETTA PTY LTD AS TRUSTEE FOR HENSHALL FAMILY TRUST, Crows Nest, Queensland (AU)

(72) Inventor: Daniel HENSHALL, Crows Nest, Queensland (AU)

(21) Appl. No.: 19/141,612

(22) PCT Filed: Dec. 19, 2022
(86) PCT No.: PCT/AU2022/051534

§ 371 Date: Jun. 20, 2025

(51) Int. Cl. G06Q 30/0601

(52) U.S. Cl. CPC G06Q 30/0637

(57) ABSTRACT

A method for pre-arranged ordering from a vendor is provided, the method including steps of (a) preparing an order for a vendor; and (b) submitting the order to the vendor in response to an event. The method may include a step of communicating information relating to a customer and/or consumer of the order to the vendor. The method may include a step of presenting information on a plurality of vendors to a customer and/or consumer of the order. Related systems and computer programs are also provided.

### CROSS-REFERENCE TO RELATED APPLICATION(S)

This is a national stage application filed under 37 U.S.C. 371 based on International Patent Application No. PCT/AU2022/051534, filed Dec. 19, 2022, the entire contents of which are incorporated herein by reference in their entirety.

### FIELD

This invention relates to electronic ordering. More particularly, the invention relates, although is not limited, to a method and system for electronic submission of a pre-arranged order to a vendor.

### BACKGROUND

Electronic ordering using mobile computing technology has become ubiquitous in recent years. Currently, mobile applications are increasingly being used for ordering of food and beverages. However, existing approaches for application-based ordering of food and beverages are associated with certain challenges.

Pre-ordering of food or beverages using existing approaches is based on a customer estimating a time of dining or collection. Where customer arrival is delayed, this can result in food or beverages reaching an undesirable temperature (e.g. hot food becoming cold or vice versa) or becoming otherwise unfresh. Furthermore, uncollected orders can accumulate at venues, taking up limited bench space or area in warmers or coolers etc. Inaccurate estimation of dining or collection can also contribute to waste and/or profit loss if orders are not collected or paid for.

In order to capture efficiency benefits of electronic or application-based ordering without having to navigate challenges associated with pre-ordering, some hospitality venues allow for application-based ordering by customers only upon arrival at the venue itself. However, such approaches offer limited (if any) benefits for customers and may instead be considered undesirable due to added ordering complexity and/or a reduction in personal service. In instances wherein a hospitality venue allows for application-based ordering only upon arrival, typically, customers must bring their smartphone out at the table and enter payment details or use tablets provided by the venue. These options can be inconvenient and, particularly in the case of the latter, can raise hygiene and disease control concerns.

Customers with mobility limitations face significant additional challenges when ordering from venues, including hospitality venues. In the context of pre-ordering, it is generally more difficult for customers with mobility limitations to confidently predict a time of arrival at a venue due to increased prospects of delay. Furthermore, it can be difficult for customers with mobility limitations to predict access challenges that may arise upon arrival at a venue. Even for venues that can accommodate different access needs, such as by preparing portable ramps or bringing food and beverages to an accessible location in or near the venue, it may take substantial time to make these arrangements upon customer arrival, particularly if staff are otherwise busy. It may also be difficult for customers with different access needs to communicate access requirements upon arrival. In the case that a venue is willing to accommodate different access needs by delivering orders to a customer at or near to the venue, monitoring for arrival of the customer may nevertheless present challenges with staff required to leave a station to look for the customer.

With the preceding in mind, it would be desirable to develop new approaches for electronic ordering of goods and services. It would be particularly desirable, in at least some instances, to develop new approaches facilitating pre-arranged ordering from hospitality venues addressing one or more of the challenges discussed above.

The reference to prior art in the background is not and should not be taken as an acknowledgement or suggestion that the referenced prior art forms part of the common general knowledge in any country or jurisdiction.

### SUMMARY

The present invention broadly provides a method for pre-arranged ordering from a vendor. Suitably, the method is an electronic method. In embodiments, the method is for pre-arranged online ordering from a vendor.

Also broadly provided according to the invention is a computational system for pre-arranged ordering from a vendor.

A first aspect of the invention provides a method for pre-arranged ordering from a vendor, the method including steps of (a) preparing an order for a vendor; and (b) submitting the order to the vendor in response to an event.

The method of the first aspect may be a method for pre-arranged ordering from a hospitality vendor, the method including steps of (a) preparing an order for a hospitality vendor, such as a food or beverage order; and (b) submitting the order to the hospitality vendor in response to an event.

Suitably, the order for the vendor is prepared by a customer.

Suitably, the customer prepares the order to be obtained from the vendor by a consumer.

The consumer that obtains the order from the vendor may be or include a consumer that is the customer that prepares the order for the vendor.

The consumer that obtains the order from the vendor may be or include a consumer that is not the customer that prepares the order for the vendor.

Suitably, the order for the vendor is prepared using a computing device. In embodiments, the computing device is a customer computing device. In embodiments, the customer computing device is a mobile computing device, such as a smartphone or tablet. In embodiments, the customer computing device is a desktop computing device.

Suitably, the order for the vendor is submitted to the vendor using a computing device. In embodiments, the computing device is the customer computing device. In embodiments, the computing device is a consumer computing device. In embodiments, the consumer computing device is a mobile computing device such as a smartphone or tablet.

Suitably, the order for the vendor is submitted to a vendor computing device in response to the event. The vendor computing device may be a desktop computing device or a mobile computing device.

In embodiments of the method of the first aspect, the event in response to which the order is submitted to the vendor, or a parameter thereof, is selectable.

In embodiments of the method of the first aspect, the event in response to which the order is submitted to the vendor, or a parameter thereof, is adjustable.

In embodiments of the method of the first aspect, the event in response to which the order is submitted to the vendor, or a parameter thereof, is customisable.

In embodiments wherein the event is a selectable, adjustable, and/or customisable event, the event may be selectable, adjustable, and/or customisable by the customer. Suitably, the event is selectable, adjustable, and/or customisable by the customer using the customer computing device.

In embodiments wherein the event according to the method of the first aspect is a selectable, adjustable, and/or customisable event, the event may be selectable, adjustable, and/or customisable by the consumer. Suitably, the event is selectable, adjustable, and/or customisable by the consumer using the consumer computing device.

In embodiments wherein the event according to the method of the first aspect is a selectable, adjustable, and/or customisable event, the event may be selectable, adjustable, and/or customisable by the vendor. Suitably, the event is selectable, adjustable, and/or customisable using the vendor computing device.

The event in response to which the order is submitted to the vendor according to the method of the first aspect may be or include a confirmation event.

In embodiments, the confirmation event is a code event. The code event may be entry of a code into a computing device. The code event may be scanning of a code using a computing device.

In embodiments, the code event is performed by the customer. The code event may be actioned or triggered using the customer computing device, such as using Quick Response (QR) code or Near Field Communication (NFC) functionality of the customer computing device.

In embodiments, the code event is performed by the consumer. The code event may be actioned or triggered using the consumer computing device, such as using Quick Response (QR) code functionality or Near Field Communication (NFC) functionality of the consumer computing device.

In embodiments wherein the consumer includes a first consumer that is the customer that prepares the order and a second consumer that is not the customer that prepares the order, the code event may include a first code event performed by the first consumer and a second code event performed by the second consumer.

The event in response to which the order is submitted to the vendor according to the method of the first aspect may be a proximity event.

In embodiments, the proximity event relates to proximity of the customer to a location. The location may be a location of the vendor. The proximity event may be triggered using the customer computing device, such as using Global Positioning System (GPS) or iBeacon functionality of the customer computing device.

In embodiments, the proximity event relates to proximity of the consumer to a location. The location may be a location of the vendor. The proximity event may be triggered using the consumer computing device, such as using Global Positioning System (GPS) or iBeacon functionality of the consumer computing device.

In embodiments wherein the consumer is or includes a consumer that is not the customer that prepares the order, the proximity event may relate to proximity of the customer to the consumer. The proximity event may be triggered using the customer and the consumer computing devices, such as using Global Positioning System (GPS) or iBeacon functionality of the customer and consumer computing devices.

The event in response to which the order is submitted to the vendor according to the method of the first aspect may be a duration event.

In embodiments, the duration event relates to estimated duration until the customer is present at a location. The location may be a location of the vendor. The duration event may be triggered using the customer computing device, such as using GPS navigation or iBeacon functionality, or the like, of the customer computing device.

In embodiments, the duration event relates to estimated duration until the consumer is present at a location. The location may be a location of the vendor. The duration event may be triggered using the consumer computing device, such as using GPS navigation functionality or iBeacon navigation functionality, or the like, of the consumer computing device.

In embodiments wherein the consumer is or includes a consumer that is not the customer that prepares the order, the duration event may relate to estimated duration until the consumer and the customer are present at a shared location. The shared location may be a location of the vendor. The duration event may be triggered using the customer and the consumer computing devices, such as using GPS navigation or iBeacon navigation functionality, or the like, of the customer and consumer computing device.

In typical embodiments of the method of the first aspect, the event in response to which the order is submitted to the vendor according to step (b) is an event, such as the confirmation, proximity, or duration event, that is substantially separate or distinct from the preparation of the order for the vendor according to step (a).

The substantially separate or distinct event in response to which the order is submitted according to step (b) may be temporally distinct from the preparation of the order for the vendor according to step (a), occurring at a substantially distinct time from the preparation of the order.

The substantially separate or distinct event in response to which the order is submitted according to step (b) may be spatially distinct from the preparation of the order for the vendor according to step (a), occurring at a substantially distinct location from the preparation of the order.

The substantially separate or distinct event in response to which the order is submitted according to step (b) may be temporospatially distinct from the preparation of the order for the vendor according to step (a), occurring at a substantially distinct time and location from the preparation of the order.

The substantially separate or distinct event in response to which the order is submitted according to step (b) may be physically distinct from the preparation of the order for the vendor according to step (a), involving a substantially distinct physical action from the preparation of the order.

In an alternative form of the method of the first aspect, the event in response to which the order is submitted to the vendor according to step (b) is a simple event.

In embodiments, the simple event according to the alternative form of the method of the first aspect occurs at substantially the same time as the preparation of the order for the vendor according to step (a).

In embodiments, the simple event according to the alternative form of the method of the first aspect occurs at substantially the same location as the preparation of the order for the vendor according to step (a).

In embodiments, the simple event according to the alternative form of the method of the first aspect includes no substantially distinct physical action from the preparation of the order for the vendor according to step (a).

According to the alternative form of the method of the first aspect, the simple event, or a part thereof, may be of or comprise the preparation of the order for the vendor according to step (a).

In embodiments, the simple event according to the alternative form of the method of the first aspect is a reservation event. Suitably, the reservation event includes entry or selection of a requirement for fulfilment of the order by the vendor. In embodiments, the requirement includes a date requirement for fulfilment of the order by the vendor. In embodiments, the requirement includes a time requirement for fulfilment of the order by the vendor.

The method of the first aspect may include a step of communicating information relating to the customer and/or consumer to the vendor. Suitably, the information relating to the customer and/or consumer is communicated to the vendor computing device.

In embodiments, the information relating to the customer and/or consumer is communicated to the vendor using the customer computing device. In embodiments, the information relating to the customer and/or consumer is communicated to the vendor using the consumer computing device.

The information relating to the customer and/or consumer that is communicated to the vendor may include identification information. Suitably, the identification information is for allowing the vendor to identify the customer and/or consumer at a location of the vendor.

In embodiments, the identification information includes name information. The name information may include a first and/or last name of the customer and/or consumer.

In embodiments, the identification information includes visual information. The visual information may include a visual depiction of the customer and/or consumer. The visual information may include a visual description of the customer and/or consumer.

In embodiments, the identification information includes transportation information. The transportation information may include a visual depiction of a vehicle transporting the customer and/or consumer. The transportation information may include a visual description of a vehicle transporting the customer and/or consumer. The transportation information may include a registration number of a vehicle transporting the customer and/or consumer.

The information relating to the customer and/or consumer that is communicated to the vendor may include party size information. The party size information suitably includes a number or approximate number of individuals including the customer and/or consumer that will be attending the vendor together.

The information relating to the customer and/or consumer that is communicated to the vendor may include accessibility information. The accessibility information may relate to mobility limitations of the customer and/or consumer. The accessibility information may be a requirement for a ramp or elevator to allow the customer and/or consumer to access the vendor. The accessibility information may be a requirement to have an order provided to the customer and/or consumer at a specific location within or outside of the vendor. The accessibility information may be a requirement for disabled parking at or near to the vendor. The accessibility information may be a requirement for disabled bathrooms at or near to the vendor.

The information relating to the customer and/or consumer communicated to the vendor may include disease control information. The disease control information may relate to limiting potential exposure of the customer and/or consumer and/or the vendor to an infectious disease. The disease control information may be a requirement to wear personal protective equipment (PPE), such as a respiratory mask. The disease control information may be a requirement to maintain physical distance from the customer and/or consumer. The disease control information may be a requirement to maintain at least a minimum distance among members of a party including the customer and/or consumer. The disease control information may be a requirement to leave an ordered product in a particular location to avoid direct contact with the customer and/or consumer.

According to the method of the first aspect, the information relating to the customer and/or consumer may be communicated to the vendor at any suitable time. In embodiments, the information relating to the customer and/or consumer is communicated concurrently, or substantially concurrently, with submission of the order to the vendor according to step (b). In embodiments, the information relating to the customer and/or consumer is communicated concurrently, or substantially concurrently, with preparation of the order for the vendor according to step (a).

The method of the first aspect may include a step of presenting information on one or more or a plurality of vendors, prior to preparing the order for the vendor.

Suitably, the information on the one or more vendors is presented to the customer and/or consumer. Suitably, the information on the one or more vendors is presented using a computing device. In embodiments, the information is presented to the customer using the customer computing device. In embodiments, the information is presented to the consumer using the consumer computing device.

The information on the one or more vendors may include proximity information. In embodiments, the proximity information includes proximity of a location of the one or more vendors from the customer. In embodiments, the proximity information includes proximity of a location of the one or more vendors from the consumer.

The information on the one or more vendors may include duration information. In embodiments, the duration information includes estimated duration until the customer is present at a location of the one or more vendors. In embodiments, the duration information includes estimated duration until the consumer is present at a location of the one or more vendors.

The information on the one or more vendors may include availability information. In embodiments, the availability information includes information on availability of one or more goods or services of interest to the customer. In embodiments, the availability information includes information on availability of one or more goods or services of interest to the consumer.

The information on the one or more vendors may include accessibility information. In embodiments, the accessibility information includes whether particular accessibility needs can be accommodated by the one or more vendors.

A second aspect of the invention provides a system for pre-arranged ordering from a vendor, the system comprising a computing device for preparing an order for a vendor; and a computing device for receiving the order for the vendor.

The system of the second aspect may be a system for pre-arranged ordering from a hospitality vendor, the system comprising a computing device for preparing an order for a hospitality vendor, such as a food or beverage order; and a computing device for receiving the order for the hospitality vendor.

In embodiments, the computing device for preparing the order for the vendor is a customer computing device. The customer computing device for preparing the order may be a mobile computing device such as a smartphone or tablet. The customer computing device for preparing the order may be a desktop computing device.

In embodiments, the computing device for receiving the order for the vendor is a vendor computing device. The vendor computing device may be a desktop computing device. The vendor computing device may be a mobile computing device such as a smartphone or tablet.

Suitably, the system of the second aspect comprises a computing device for submitting the prepared order to the vendor in response to an event. The computing device for submitting the prepared order to the vendor may be a mobile computing device such as a smartphone or tablet.

In embodiments, the computing device for submitting the prepared order to the vendor is the customer computing device.

In embodiments, the computing device for submitting the prepared order to the vendor is a consumer computing device. Suitably, the consumer computing device is a mobile computing device such as a smartphone or tablet.

The computing device of the system of the second aspect for preparing the order for the vendor may comprise a software application for preparing the order. The software application for preparing the order may be a customer application.

The computing device of the system of the second aspect for receiving the order for the vendor may comprise a software application for receiving the order. The software application for receiving the order may be a vendor application.

The computing device of the system of the second aspect for submitting the prepared order may comprise a software application for submitting the order. The software application for submitting the order may be the customer application. The application for submitting the order may be a consumer application. The customer application and the consumer application may be different applications or the same application.

In embodiments, the computing device of the system for submitting the prepared order to the vendor in response to the event is for submitting the prepared order in response to an event, or a parameter thereof, that is selectable.

In embodiments, the computing device of the system for submitting the prepared order to the vendor in response to the event is for submitting the prepared order in response to an event, or a parameter thereof, that is adjustable.

In embodiments, the computing device of the system for submitting the prepared order to the vendor in response to the event is for submitting the prepared order in response to an event, or a parameter thereof, that is customisable.

The selectable, adjustable, and/or customisable event, or parameter thereof, in response to which the computing device of the system submits the prepared order to the vendor, may be selectable, adjustable, and/or customisable with the customer computing device.

The selectable, adjustable, and/or customisable event, or parameter thereof, in response to which the computing device of the system submits the prepared order to the vendor, may be selectable, adjustable, and/or customisable with the customer application.

The selectable, adjustable, and/or customisable event, or parameter thereof, in response to which the computing device of the system submits the prepared order to the vendor, may be selectable, adjustable, and/or customisable with the consumer computing device.

The selectable, adjustable, and/or customisable event, or parameter thereof, in response to which the computing device of the system submits the prepared order to the vendor, may be selectable, adjustable, and/or customisable with the consumer application.

The selectable, adjustable, and/or customisable event, or parameter thereof, in response to which the computing device of the system is for submitting the prepared order to the vendor, may be selectable, adjustable, and/or customisable with the vendor computing device.

The selectable, adjustable, and/or customisable event, or parameter thereof, in response to which the computing device of the system is for submitting the prepared order to the vendor, may be selectable, adjustable, and/or customisable with the vendor application.

The selectable, adjustable, and/or customisable event, or parameter thereof, in response to which the computing device of the system submits the prepared order to the vendor, may be a proximity event.

In embodiments, the proximity event occurs when a location of the customer computing device is within a defined proximity of a location of the vendor. The proximity event may be detected with GPS or iBeacon functionality, or the like, of the customer computing device. The proximity event may be triggered with the customer application.

In embodiments, the proximity event occurs when a location of the consumer computing device is within a defined proximity of a location of the vendor. The proximity event may be detected with GPS or iBeacon functionality, or the like, of the consumer computing device. The proximity event may be triggered with the consumer application.

In embodiments wherein the customer computing device and the consumer computing device are different computing devices, the proximity event may occur when a location of the customer computing device and a location of the consumer computing device are within a defined proximity. The proximity event may be detected by GPS or iBeacon functionality, or the like, of the customer computing device and/or the consumer computing device. The proximity event may be triggered with the customer application. The proximity event may be triggered with the consumer application.

The selectable, adjustable, and/or customisable event, or parameter thereof, in response to which the computing device of the system submits the prepared order to the vendor, may be a duration event.

In embodiments, the duration event occurs when a location of the customer computing device is within a defined travel duration of a location of the vendor. The duration event may be detected with navigation functionality, such as GPS navigation or iBeacon navigation functionality, of the customer computing device. The duration event may be triggered with the customer application.

In embodiments, the duration event occurs when a location of the consumer computing device is within a defined travel duration of a location of the vendor. The duration event may be detected with navigation functionality, such as GPS navigation or iBeacon navigation functionality, of the consumer computing device. The duration event may be triggered with the consumer application.

In embodiments wherein the customer computing device and the consumer computing device are different computing devices, the duration event may occur when a location of the customer computing device and a location of the consumer computing device are within a defined travel duration. The duration event may be detected by navigation functionality, such as GPS navigation or iBeacon navigation functionality, of the customer computing device and/or the consumer computing device. The duration event may be triggered by the customer application. The duration event may be triggered with the consumer application.

In an alternative form of the system of the second aspect, the computing device of the system submits the prepared order to the vendor in response to a simple event. In embodiments, the simple event according to the alternative form of the system of the second aspect is a reservation event. The reservation event may include entry or selection of a date requirement for fulfilment of the order by the vendor. The reservation event may include entry or selection of a time requirement for fulfilment of the order by the vendor.

The simple event, according to the alternative form of the system of the second aspect, such as the reservation event, may be performed using the customer computing device. The simple event may be triggered with the customer application.

In embodiments of the alternative form of the system of the second aspect the prepared order is submitted to the vendor concurrently, or substantially concurrently, with occurrence of the simple event, such as the reservation event.

In embodiments, the system of the second aspect can communicate information relating to the customer and/or consumer to the vendor. Suitably, the information relating to the customer and/or consumer can be communicated to the vendor computing device.

In embodiments, the customer computing device can communicate information relating to the customer and/or consumer to the vendor. In embodiments, the customer computing device can communicate information relating to the customer and/or consumer to the vendor with the customer application.

In embodiments, the consumer computing device can communicate information relating to the customer and/or consumer to the vendor. In embodiments, the consumer computing device can communicate information relating to the customer and/or consumer to the vendor with the consumer application.

The information relating to the customer and/or consumer that can be communicated to the vendor with the system of the second aspect may include identification information. Suitably, the identification information is for allowing the vendor to identify the customer and/or consumer at a location of the vendor.

In embodiments, the identification information includes name information. The name information may include a first and/or last name of the customer and/or consumer.

In embodiments, the identification information includes visual information. The visual information may include a visual depiction of the customer and/or consumer. The visual information may include a visual description of the customer and/or consumer.

In embodiments, the identification information includes transportation information. The transportation information may include a visual depiction of a vehicle transporting the customer and/or consumer. The transportation information may include a visual description of a vehicle transporting the customer and/or consumer. The transportation information may include a registration number of a vehicle transporting the customer and/or consumer.

The information relating to the customer and/or consumer that is communicated to the vendor may include party size information. The party size information suitably includes a number or approximate number of individuals including the customer and/or consumer that will be attending the vendor together.

The information relating to the customer and/or consumer that is communicated to the vendor may include accessibility information. The accessibility information may relate to mobility limitations of the customer and/or consumer. The accessibility information may be a requirement for a ramp or elevator to allow the customer and/or consumer to access the vendor. The accessibility information may be a requirement to have an order delivered to the customer and/or consumer at a specific location within or outside of the vendor. The accessibility information may be a requirement for disabled parking at or near to the vendor. The accessibility information may be a requirement for disabled bathrooms at or near to the vendor.

The information relating to the customer and/or consumer communicated to the vendor may include disease control information. The disease control information may relate to limiting potential exposure of the customer and/or consumer and/or the vendor to an infectious disease. The disease control information may be a requirement to wear personal protective equipment (PPE), such as a respiratory mask. The disease control information may be a requirement to maintain physical distance from the customer and/or consumer. The disease control information may be a requirement to maintain at least a minimum distance among members of a party including the customer and/or consumer. The disease control information may be a requirement to leave an ordered product in a particular location to avoid direct contact with the customer and/or consumer.

The system of the second aspect may communicate the information relating to the customer and/or consumer to the vendor at any suitable time. In embodiments, the information relating to the customer and/or consumer is communicated concurrently, or substantially concurrently, with submission of the prepared order to the vendor. In embodiments, the information relating to the customer and/or consumer is communicated concurrently, or substantially concurrently, with preparation of the order for the vendor.

In embodiments, the system of the second aspect can present information relating to one or more or a plurality of vendors, prior to preparation of the order for the vendor.

In embodiments, the information relating to the one or more vendors is presented with the customer computing device. The information relating to the one or more vendors may be presented with the customer application.

In embodiments, the information relating to the one or more vendors is presented with the consumer computing device. The information relating to the one or more vendors may be presented with the consumer application.

The information relating to the one or more vendors may include proximity information. In embodiments, the proximity information includes proximity of a location of the one or more vendors from a location of the customer computing device. In embodiments, the proximity information includes proximity of a location of the one or more vendors from a location of the consumer computing device.

The information relating to the one or more vendors may include duration information. In embodiments, the duration information includes estimated travel duration between a location of the customer computing device and a location of the one or more vendors. In embodiments, the duration information includes estimated travel duration between a location of the consumer computing device and a location of the one or more vendors.

The information relating to the one or more vendors may include operating information. In embodiments, the operating information includes standard operating hours of the one or more vendors. In embodiments, the operating information includes whether the one or more vendors are currently open or closed.

The information relating to the one or more vendors may include availability information. In embodiments, the availability information includes information on availability of one or more goods or services of interest to the customer. In embodiments, the availability information includes information on availability of one or more goods or services of interest to the consumer.

The information relating to the one or more vendors may include accessibility information. In embodiments, the accessibility information includes whether particular accessibility needs can be accommodated by the one or more vendors.

A third aspect of the invention includes a computer program for preparing an order for a vendor; and submitting the order to the vendor in response to an event.

In embodiments, the program of the third aspect is for preparing an order for a hospitality vendor, such as a food or beverage order; and submitting the order to the vendor in response to an event.

Suitably, the program of the third aspect is for use according to the method of the first aspect.

In embodiments, the program of the third aspect is or includes the customer application of the system of the second aspect.

In embodiments, the program of the third aspect is or includes the vendor application of the system of the second aspect.

In embodiments, the program of the third aspect is or includes the consumer application of the system of the second aspect.

### BRIEF DESCRIPTION OF THE DRAWINGS

The invention will be described hereinafter with reference to typical embodiments illustrated in the drawings and wherein:

FIG. 1 sets forth a schematic illustration of an embodiment of a system according to the invention, system 10.

FIG. 2 sets forth a schematic illustration of another embodiment of a system according to the invention, system 11.

FIG. 3 sets forth a schematic illustration of another embodiment of a system according to the invention, system 12.

FIG. 4 sets forth a schematic illustration of a proximity event involving customer 1 and vendor 2 during use of system 10. A-1 is a proximity of customer computing device 100 to vendor 2 in response to which the proximity event occurs.

FIG. 5 sets forth a schematic illustration of a proximity event involving consumer 3 and vendor 2 during use of system 11. A-2 is a proximity of consumer computing device 300 to vendor 2 in response to which the proximity event occurs.

FIG. 6 sets forth a schematic illustration of a proximity event involving customer 1, consumer 3, and vendor 2 during use of system 12. A-3 is a proximity of customer computing device 100 and consumer computing device 300 to vendor 2 in response to which the proximity event occurs.

FIG. 7 sets forth a schematic illustration of a proximity event involving customer 1 and consumer 3 during use of system 12. A-4 is a proximity of customer computing device 100 to consumer computing device 300 in response to which the proximity event occurs.

FIG. 8 sets forth a schematic illustration of a code-scanning event involving customer 1 and vendor 2 during use of system 10. B-1 is a QR code scanned by customer computing device 100 in response to which the code-scanning event occurs.

FIG. 9 sets forth a schematic illustration of a code-scanning event involving consumer 3 and vendor 2 during use of system 11. B-2 is a QR code scanned by consumer computing device 300 in response to which the code-scanning event occurs.

FIG. 10 sets forth a schematic illustration of a code-scanning event involving customer 1, consumer 3, and vendor 2 during use of system 12. B-3 is a QR code scanned by customer computing device 100 and consumer computing device 300 in response to which the code-scanning event occurs.

FIG. 11 sets forth a schematic illustration of use of system 10 wherein an image of customer 1 is transmitted to allow identification of customer 1. Staff member 22 of vendor 2 is shown in FIG. 11. C-1 is a location within or near to vendor 2, at which staff member 22 identifies customer 1.

FIG. 12 sets forth a schematic illustration of use of system 10 wherein an image of a vehicle transporting customer 1 is transmitted to allow monitoring for arrival of customer 1. Staff member 22 of vendor 2 is shown in FIG. 12. C-2 is a location within or near to vendor 2, at which staff member 22 monitors for arrival of customer 1.

FIG. 13 sets forth a schematic illustration of use of system 10 wherein information on accessibility requirements of customer 1 is transmitted to allow appropriate service of customer 1. Staff member 22 of vendor 2 is shown in FIG. 12. C-3 is a location within or near to vendor 2, at which staff member 22 attends to accessibility requirements of customer 1.

FIGS. 14A-14C set forth introduction screens of an embodiment of a computer program according to an aspect of the invention, program 50.

FIGS. 15A-15C set forth GUI screenshots of program 50.

### DETAILED DESCRIPTION

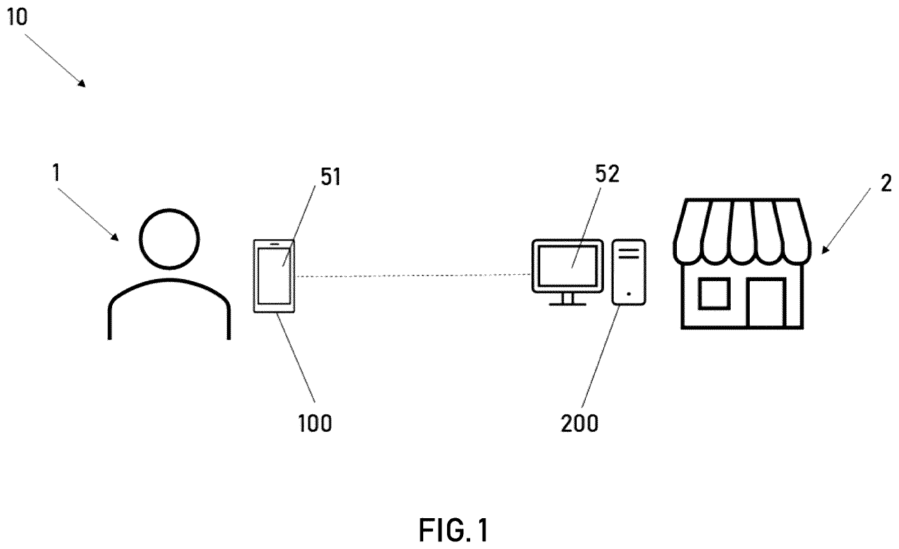

FIG. 1 illustrates an embodiment of a system according to an aspect of the invention, system 10.

System 10 comprises customer computing device 100 for use by customer 1; and vendor computing device 200 for use by vendor 2.

Customer computing device 100 of system 10 is a mobile computing device, more typically a smartphone. Customer computing device 100 of system 10 comprises wireless signalling functionality; GPS functionality, including navigation functionality; and code-scanning functionality.

Vendor computing device 200 of system 10 may be a desktop computing device (as depicted in FIG. 1) or a mobile computing device, such as a smartphone, tablet, or laptop. Vendor computing device 200 of system 10 comprises wireless signalling functionality.

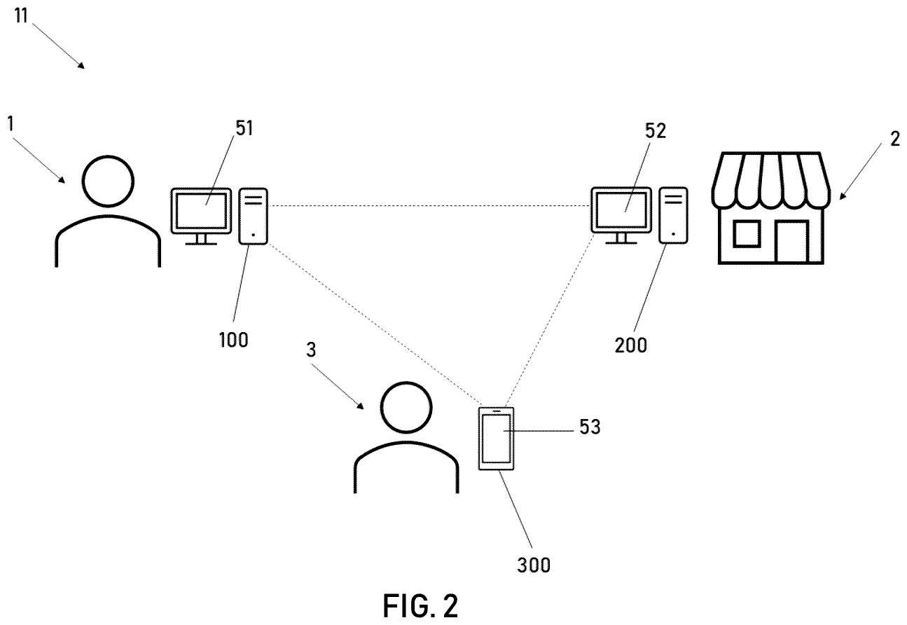

FIG. 2 illustrates another embodiment of a system according to an aspect of the invention, system 11.

System 11 comprises customer computing device 100 for use by customer 1; vendor computing device 200 for use by vendor 2; and consumer computing device 300 for use by consumer 3.

Customer computing device 100 of system 11 may be a desktop computing device (as shown in FIG. 2) or a mobile computing device, such as a smartphone, tablet, or laptop. Customer computing device 100 of system 11 comprises wireless signalling functionality.

Vendor computing device 200 of system 11 may be a desktop computing device (as depicted in FIG. 2) or a mobile computing device, such as a smartphone, tablet, or laptop. Vendor computing device 200 of system 11 comprises wireless signalling functionality.

Consumer computing device 300 of system 11 is a mobile computing device, more typically a smartphone. Consumer computing device 300 of system 11 comprises wireless signalling functionality; GPS functionality, including navigation functionality; and code-scanning functionality.

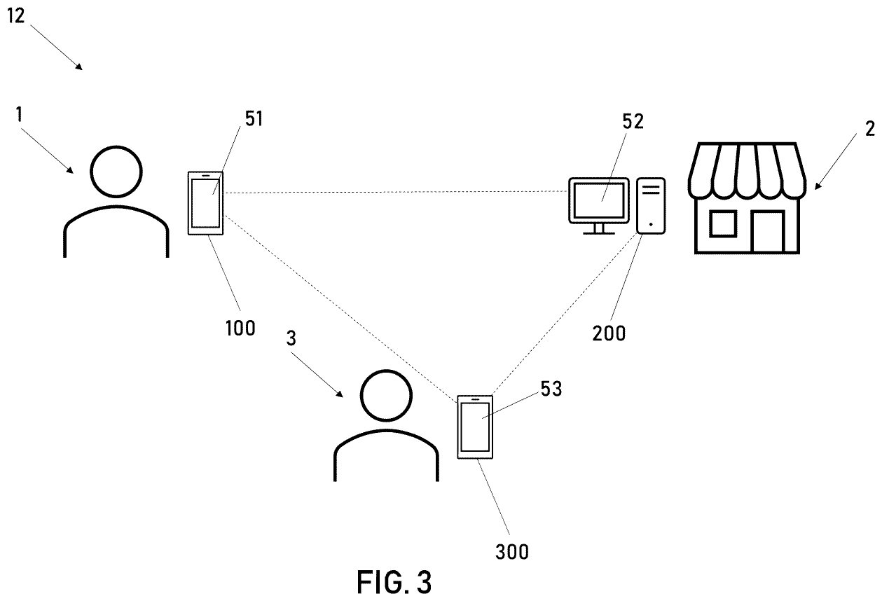

FIG. 3 illustrates another embodiment of a system according to an aspect of the invention, system 12.

System 12 comprises customer computing device 100 for use by customer 1; vendor computing device 200 for use by vendor 2; and consumer computing device 300 for use by consumer 3.

Customer computing device 100 of system 12 is a mobile computing device, more typically a smartphone. Customer computing device 100 of system 12 comprises wireless signalling functionality; GPS functionality, including navigation functionality; and code-scanning functionality.

Vendor computing device 200 of system 12 may be a desktop computing device (as depicted in FIG. 3) or a mobile computing device, such as a smartphone, tablet, or laptop. Vendor computing device 200 of system 12 comprises wireless signalling functionality.

Consumer computing device 300 is a mobile computing device, more typically a smartphone. Consumer computing device 300 of system 12 comprises wireless signalling functionality; GPS functionality, including navigation functionality; and code-scanning functionality.

Suitable software is installed and/or running on customer computing device 100, vendor computing device 200, and/or consumer computing device 300 of systems 10, 11, and 12 to facilitate use of systems 10, 11, and 12.

Customer application 51 is typically installed and/or running on customer computing device 100. Customer application 51 is, or is of, a computer program according to an aspect of the invention, program 50. More particularly, customer application 51 is a customer version or component of program 50.

Vendor application 52 is typically installed and/or running on vendor computing device 200. Vendor application 52 is, or is of, computer program 50. More particularly, vendor application 52 is a vendor version or component of program 50.

Consumer application 53 is typically installed and/or running on consumer computing device 300. Consumer application 53 is, or is of, computer program 50. More particularly, consumer application 53 is a consumer version or component of program 50. In some embodiments, consumer application 53 is, or is substantially the same as, customer application 51.

Typical use of systems 10, 11, and 12 will now be described.

Systems 10, 11, and 12 are typically used for pre-arranged ordering by customer 1 of a good or service from vendor 2.

More typically, systems 10, 11, and 12 are used for pre-arranged ordering of food and/or beverages from vendor 2, wherein vendor 2 is a hospitality vendor offering either or both of dine in and takeaway food and/or beverage provision options. Use of systems 10, 11, and 12 will primarily be described with reference to food and/or beverage provision, although it will be clearly understood that use of systems 10, 11, and 12 is not so limited.

System 10 is for use by customer 1 and vendor 2. Typically, system 10 is used for pre-ordering by customer 1 from vendor 2; submission of the pre-order to vendor 2 in response to a defined event involving customer 1; and obtaining of pre-ordered goods or services by customer 1 from vendor 2.

In typical use, customer 1 places a pre-order for food and/or beverages from vendor 2 with computing device 100 and customer application 51. Customer application 51 allows for the pre-order to be entered and finalised, and for payment to be processed. Details of the pre-order and/or payment processing can be stored with computing device 100 using customer application 51.

In typical use, when the pre-order is placed with computing device 100 and customer application 51, the pre-order is not immediately submitted to vendor 2. Rather, submission of the pre-order to vendor 2 occurs in response to a defined event.

In typical use, customer 1 selects, adjusts, and/or customises the defined event in response to which the pre-order is to be submitted to vendor 2. Typically, selection, adjustment, and/or customisation of the defined event is performed by customer 1 with computing device 100 and customer application 51.

In typical use, customer 1 may select between a proximity event and a code entry event as the defined event in response to which the pre-order will be submitted to vendor 2.

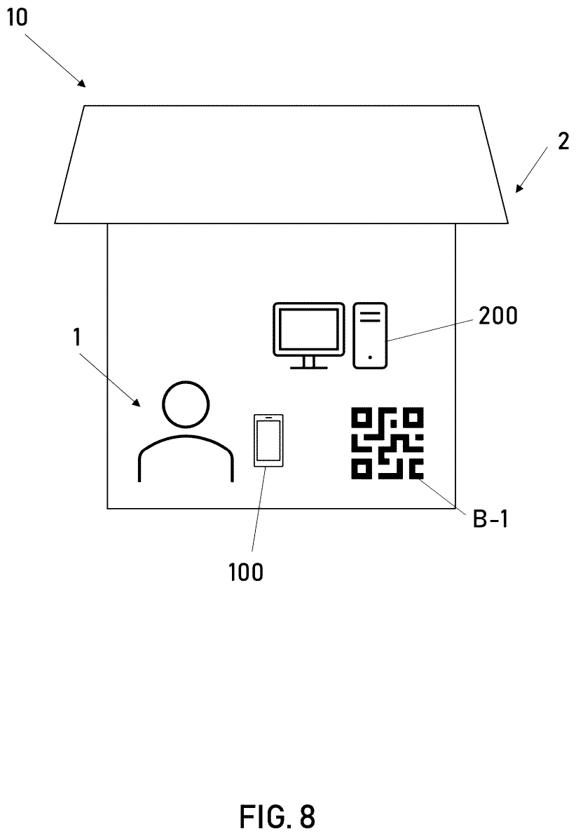

Typically, the code entry event is or includes entry of a code available at a location of vendor 2 with computing device 100 and customer application 51. Typically, the code is a QR code or the like. Typically, the code is scanned and entered using code-scanning functionality of computing device 100 in conjunction with application 51. A schematic illustration of a code entry event during use of system 10 is provided in FIG. 8.

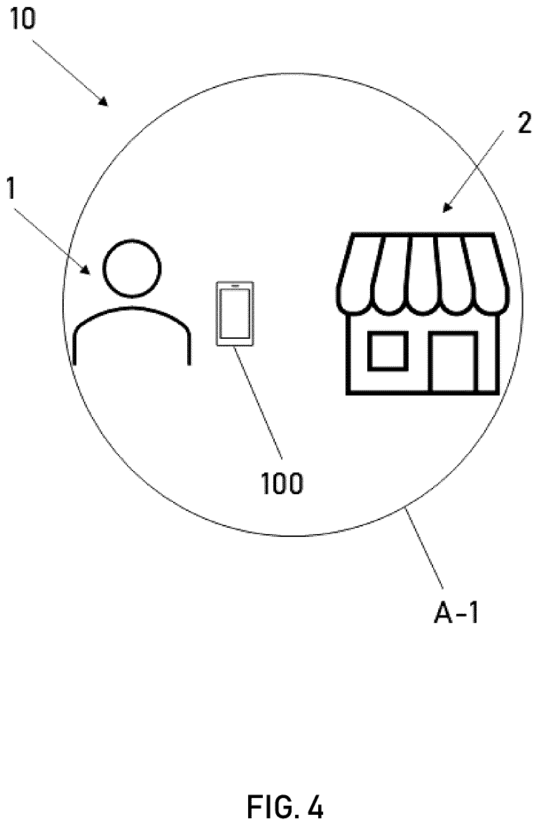

Typically, the proximity event is or includes the presence of computing device 100 within a defined proximity from a location of vendor 2. Typically, the proximity event is detected using GPS functionality of computing device 100 in conjunction with application 51. A schematic illustration of a proximity event during use of system 10 is provided in FIG. 4.

Typically, a proximity value for the proximity event is selected, adjusted, or customised by customer 1 using computing device 100 and application 51. The proximity value may be any suitable value.

In some typical embodiments, the proximity value is a value in metres (m) or an equivalent value in a different unit of measurement, such as yards (yd).

In some embodiments, the proximity value is between about 1 and about 10 m, including about 2, 3, 4, 5, 6, 7, 8, and 9 m.

In some typical embodiments, the proximity value is between about 10 and about 1000 m, including about 50, 100, 150, 200, 250, 300, 350, 400, 450, 500, 550, 600, 750, 800, 850, 900, and 950 m.

In some typical embodiments, the proximity value is a value in kilometres (km) or an equivalent value in a different unit of measurement, such as miles (mi). The proximity value may be between about 1 and about 100 km, including about 2, 3, 4, 5, 6, 7, 8, 9, 10, 15, 20, 25, 30, 35, 40, 45, 50, 55, 60, 65, 70, 75, 80, 85, 90, and 95 km.

In some embodiments, in use, customer 1 can select a duration event as the defined event in response to which the pre-order will be submitted to vendor 2.

Typically, the duration event is the presence of computing device 100 within a defined travel duration from a location of vendor 2. Typically, the duration event is detected using GPS navigation functionality of computing device 100 in conjunction with application 51.

Typically, a duration value for the duration event is selected, adjusted, or customised by customer 1 using computing device 100 and application 51. The duration value may be any suitable value.

In some typical embodiments, the duration value is a value in seconds(s) or minutes (min), or an equivalent value in a different unit of measurement such as hours (h).

In some typical embodiments, the duration value is between about 30 s and about 60 min, including about 1, 2, 3, 4, 5, 6, 7, 8, 9, 10, 11, 12, 13, 14, 15, 20, 25, 30, 35, 40, 45, 50, and 55 minutes.

In some embodiments, the duration value is between about 1 h and about 12 h, including about 2, 3, 4, 5, 6, 7, 8, 9, 10, and 11 h.

In typical use of system 10, when the defined event occurs, computing device 100 immediately, or substantially immediately, submits the pre-order to vendor 2 using wireless signalling functionality of computing device 100 in conjunction with application 51.

In typical use of system 10, vendor 2 receives the submitted pre-order using wireless signalling functionality of computing device 200 in conjunction with application 52.

Typically, once vendor 2 receives the submitted pre-order in response to the defined event, vendor 2 arranges to fulfil the pre-order.

In embodiments wherein the defined event is a code entry event, typically, the service obtained by customer 1 from hospitality vendor 2 using system 10 is a dine-in service. In some embodiments wherein the defined event is a code entry event, the service obtained from hospitality vendor 2 using system 10 is a takeaway service.

In embodiments wherein the defined event is a proximity event, typically, the service obtained by customer 1 from hospitality vendor 2 using system 10 is a takeaway service. In some embodiments wherein the defined event is a proximity event, the service obtained from hospitality vendor 2 using system 10 is dine-in service.

In embodiments wherein the defined event is a duration event, typically, the service obtained by customer 1 from hospitality vendor 2 using system 10 is a takeaway service. In some embodiments wherein the defined event is a proximity event, the service obtained from hospitality vendor 2 using system 10 is a dine-in service.

In typical embodiments wherein service obtained by customer 1 from hospitality vendor 2 using system 10 is a dine-in service, when the submitted pre-order is received by vendor 2, vendor 2 typically arranges to seat customer 1 and/or commences preparation of food and/or beverages for customer 1.

In typical embodiments wherein service obtained by customer 1 from hospitality vendor 2 is a takeaway service, when the submitted pre-order is received by vendor 2, vendor 2 typically commences preparation of food and/or beverages for customer 1 and/or makes arranges to monitor for arrival of customer 1.

Typical use of system 11 shares similarities with that of system 10 as described above. However, notable differences will be apparent from the following description.

System 11 is for use by customer 1, vendor 2, and consumer 3. Typically, system 10 is used for pre-ordering by customer 1 from vendor 2; submission of the pre-order to vendor 2 in response to a defined event involving consumer 3; and obtaining of pre-ordered goods or services by consumer 3 from vendor 2.

It will be appreciated that system 11 is suitable for use wherein customer 1 wishes to arrange for goods or services to be obtained by consumer 3 from vendor 2.

As hereinabove described, in addition to customer computing device 100 for use by customer 1 and vendor computing device 200 for use by vendor 2, system 11 comprises consumer computing device 300 for use by consumer 3.

As for system 10, in typical use of system 11, customer 1 places a pre-order for food and/or beverages from vendor 2 with computing device 100 and customer application 51.

As for system 10, in typical use, the pre-order placed by customer 1 is not submitted to the vendor immediately but rather is submitted in response to a defined event.

In typical use, details of the pre-order placed by customer 1 are communicated with wireless signalling functionality of computing device 100 in conjunction with customer application 51, for review by consumer 3.

In typical use, consumer 3 receives and reviews the details of the pre-order placed by customer 1 with wireless signalling functionality of computing device 300 in conjunction with consumer application 53. In some embodiments, consumer 3 can modify the pre-order with computing device 300 and application 53.

Similarly as for system 10, in typical use of system 11, the defined event in response to which the pre-order is submitted is selected, adjusted, and/or customised.

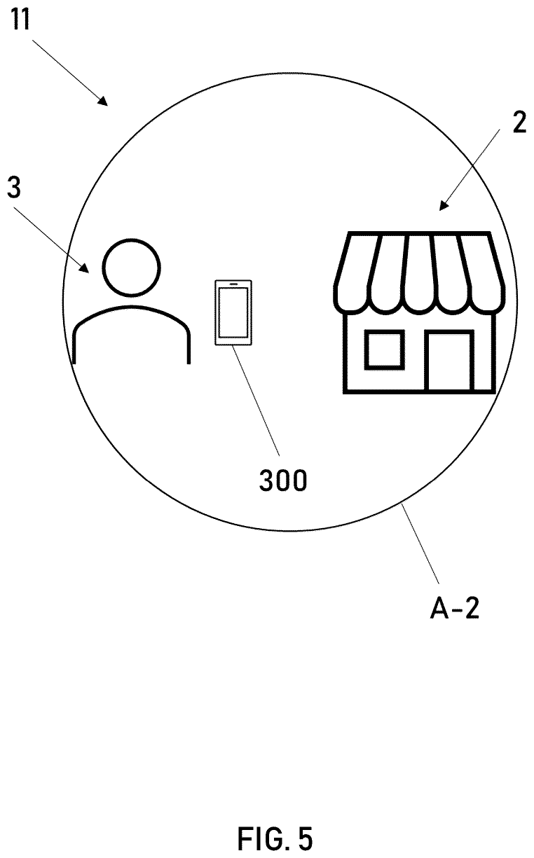

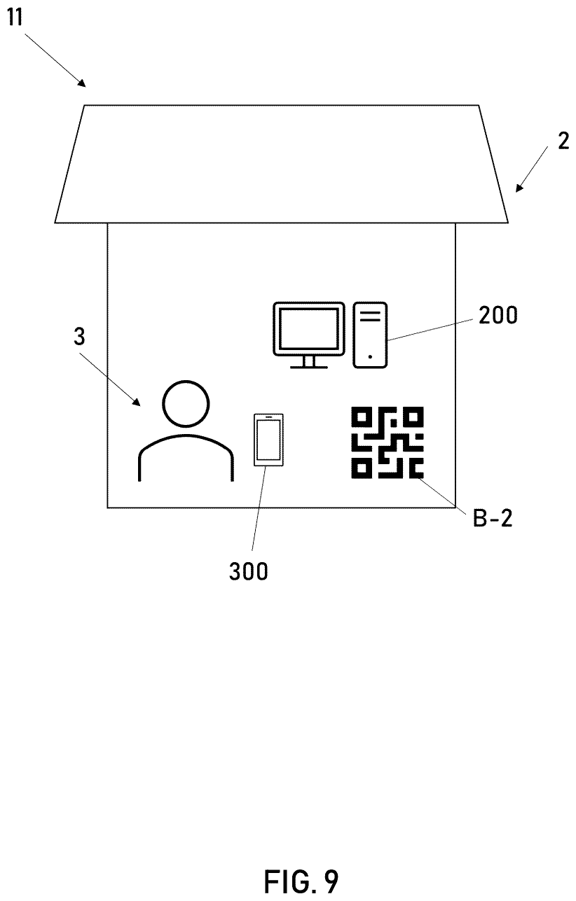

Typically, the defined event is a code entry event, a proximity event, or a duration event as hereinabove described for system 10. A schematic illustration of a code entry event during use of system 11 is provided in FIG. 9. A schematic illustration of a proximity event during use of system 11 is provided in FIG. 5.

In some typical embodiments, in use of system 11, the defined event is selected, adjusted, and/or customised by customer 1 with computing device 100 and customer application 51. Details of the defined event selected, adjusted, and/or customised by customer 1 with computing device 100 and customer application 51 are typically communicated for review by consumer 3. Consumer 3 typically receives and reviews the details of the defined event with computing device 300 and consumer application 53. In some embodiments, consumer 3 can modify the defined event with computing device 300 and consumer application 53.

In some typical embodiments, in use of system 11, the defined event is selected, adjusted, and/or customised by consumer 3 with computing device 300 and consumer application 53. Details of the defined event selected, adjusted, and/or customised by consumer 53 with computing device 300 and consumer application 53 may be communicated for review by customer 1. Customer 1 may receive and review the details of the defined event with computing device 100 and customer application 51. In some embodiments, customer 1 can modify the defined event with computing device 100 and customer application 51.

In some typical embodiments of system 11, in use, when the defined event occurs, customer device 100 immediately, or substantially immediately, submits the pre-order to vendor 2 using wireless signalling functionality of computing device 100 in conjunction with functionality of application 51.

In some typical embodiments of system 11, in use, when the defined event occurs, consumer device 300 immediately, or substantially immediately, submits the pre-order to vendor 2 using wireless signalling functionality of computing device 300 in conjunction with functionality of application 53.

Typically, once vendor 2 receives the submitted pre-order in response to the defined event, vendor 2 arranges to fulfil the pre-order. As hereinabove described, in typical use of system 11 the pre-ordered goods or services are obtained by consumer 3 from vendor 2.

In embodiments wherein the defined event is a code entry event, typically, the service obtained by consumer 3 from vendor 2 using system 11 is a dine-in hospitality service. In some embodiments wherein the defined event is a code entry event, the service obtained from hospitality vendor 2 using system 10 is a takeaway service.

In embodiments wherein the defined event is a proximity event, typically, the service obtained by consumer 3 from vendor 2 using system 11 is a takeaway hospitality service. In some embodiments wherein the defined event is a proximity event, the service obtained from hospitality vendor 2 using system 10 is a dine-in service.

In embodiments wherein the defined event is a duration event, typically, the service obtained by consumer 3 from vendor 2 using system 11 is a takeaway hospitality service, although without limitation thereto. In some embodiments wherein the defined event is a proximity event, the service obtained from hospitality vendor 2 using system 10 is a dine-in service.

In typical embodiments wherein service obtained by consumer 3 from hospitality vendor 2 using system 11 is a dine-in service, when the submitted pre-order is received by vendor 2, vendor 2 arranges to seat consumer 3 and/or commences preparation of food and/or beverages for consumer 3.

In typical embodiments wherein service obtained by consumer 3 from hospitality vendor 2 is a takeaway service, when the submitted pre-order is received by vendor 2, vendor 2 commences preparation of food and/or beverages for consumer 3 and/or arranges to monitor for arrival of consumer 3.

Typical use of system 12 shares similarities with that of system 10 and system 11 as described above. However, notable differences will be apparent from the following description.

System 12 is for use by customer 1, vendor 2, and consumer 3. Typically, system 12 is used for pre-ordering by customer 1 from vendor 2; submission of the pre-order to vendor 2 in response to a defined event involving customer 1 and/or consumer 3; and obtaining of pre-ordered goods or services by customer 1 and consumer 3 from vendor 2.

It will be appreciated that system 12 is suitable for use wherein customer 1 and consumer 3 wish to together obtain goods and/or services, such as take away or dine in food and/or beverages, from vendor 2.

As hereinabove described, in addition to customer computing device 100 for use by customer 1 and vendor computing device 200 for use by vendor 2, system 12 comprises consumer computing device 300 for use by consumer 3.

As for system 10 and system 11, in typical use of system 12 customer 1 places a pre-order for food and/or beverages from vendor 2 with computing device 100 and customer application 51.

As for system 10 and system 11, in typical use of system 12 the pre-order placed by customer 1 is not submitted to vendor 2 immediately but rather is submitted in response to a defined event.

As for system 11, in typical use of system 12 details of the pre-order placed by customer 1 are communicated with wireless signalling functionality of computing device 100 and customer application 51 for review by consumer 3.

As for system 11, in typical use of system 12, consumer 3 receives and reviews the details of the pre-order placed by customer 1 with wireless signalling functionality of computing device 300 and application 53. In some embodiments, consumer 3 can modify the pre-order with computing device 300 and functionality of application 53.

Similarly as for system 10 and system 11, the defined event in response to which the pre-order is submitted is typically selected, adjusted, and/or customised.

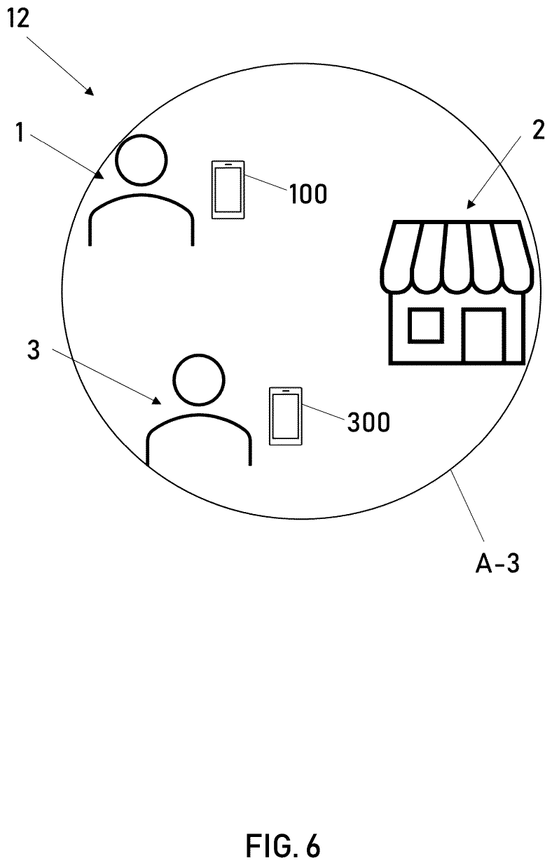

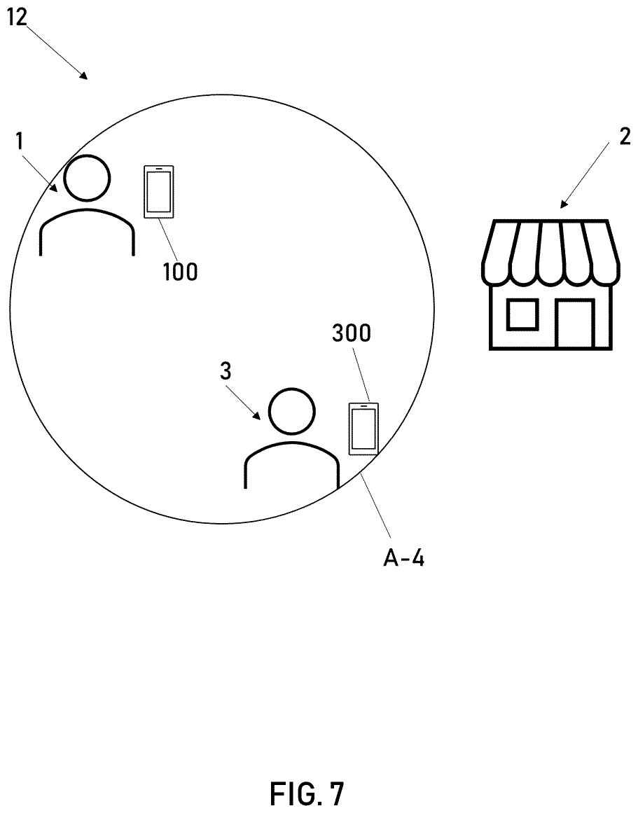

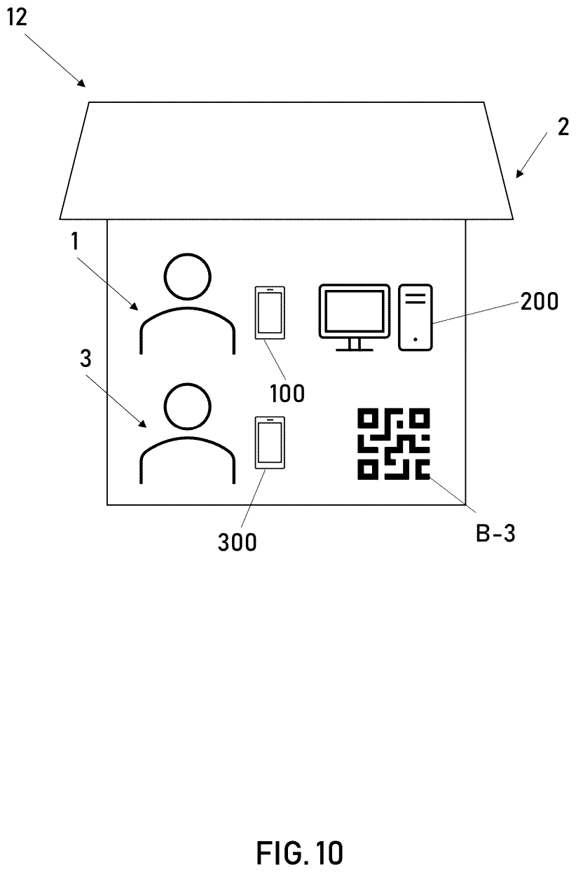

Typically, the defined event is a code entry event, a proximity event, or a duration event as hereinabove described. A schematic illustration of a code entry event during use of system 12 is provided in FIG. 10. Schematic illustrations of proximity events during use of system 12 are provided in FIG. 6 and FIG. 7.

In some typical embodiments, in use of system 12 the defined event is selected, adjusted, and/or customised by customer 1 with computing device 100 and customer application 51. Details of the defined event selected, adjusted, and/or customised by customer 1 with computing device 100 and customer application 51 may be communicated for review by consumer 3. Consumer 3 may receive and review the details of the defined event with computing device 300 and application 53. In some embodiments, consumer 3 can modify the pre-order with computing device 300 and functionality of application 53.

In some typical embodiments, in use of system 12, the defined event is selected, adjusted, and/or customised by consumer 3 with computing device 300 and consumer application 53. Details of the defined event selected, adjusted, and/or customised by consumer 53 with computing device 300 and consumer application 53 may be communication for review by customer 1. Customer 1 may receive and review the details of the defined event with computing device 100 and application 51. In some embodiments, customer 1 can modify the pre-order with computing device 100 and functionality of application 51.

In some typical embodiments, in use of system 12, a defined event, or respective defined events, involving each of customer 1 and consumer 3 are selected, adjusted, and/or customised by customer 1 with computing device 100 and customer application 51; and/or consumer 3 with computing device 300 and consumer application 53.

It will be understood that, in embodiments wherein a defined event, or respective defined events, involving each of customer 1 and consumer 3 are selected, adjusted, and/or customised, each of the defined events may be, respectively, a code entry event, a proximity event, or a duration event.

In some typical embodiments, the defined event(s) involving customer 1 and consumer 3 is a code entry event. Alternatively, one of the defined events may be a code entry event, and another of the defined events may be a proximity or a duration event.

In some typical embodiments, the defined event(s) involving customer 1 and consumer 3 is a proximity event. Alternatively, one of the defined events may be a proximity event, and another of the defined events may be a code entry event or a duration event.

In typical embodiments wherein the defined event(s) involving customer 1 and consumer 3 is a proximity event, the proximity value(s) selected for the proximity event(s) are the same or substantially the same. Alternatively, the proximity value(s) selected for the proximity event(s) may be different.

In some typical embodiments, the defined event(s) involving customer 1 and consumer 3 is a duration event. Alternatively, one of the defined events may be a duration event, and another of the defined events may be a code entry event or a duration event.

In typical embodiments wherein the defined event(s) involving customer 1 and consumer 3 is a duration event, the duration values selected for the duration event(s) are the same or substantially the same. Alternatively, the duration value(s) selected for the duration event(s) may be different.

In some typical embodiments of system 12, when the defined event(s) occurs, customer device 100 immediately, or substantially immediately, submits the pre-order to vendor 2 using wireless signalling functionality of computing device 100 and customer application 51.

In some typical embodiments of system 12, when the defined event(s) occurs, consumer device 300 immediately, or substantially immediately, submits the pre-order to vendor 2 using wireless signalling functionality of computing device 300 and consumer application 53.

It will be understood that, typically, in embodiments wherein the pre-order is submitted in response to respective defined events involving customer 1 and consumer 3, the pre-order is submitted to vendor 2 when the last of the defined events occurs.

Typically, once vendor 2 receives the submitted pre-order in response to the defined event(s), vendor 2 arranges to fulfil the pre-order. As hereinabove described, in typical use of system 12, the pre-ordered goods or services are obtained by customer 1 and consumer 3 from vendor 2.

In embodiments wherein the defined event(s) is or includes a code entry event, typically, the service obtained by customer 1 and consumer 3 from vendor 2 using system 12 is a dine-in service. In some embodiments wherein the defined event is a proximity event, the service obtained from hospitality vendor 2 using system 10 is a takeaway service.

In embodiments wherein the defined event(s) is a proximity event, typically, the service obtained by customer 1 and consumer 3 from vendor 2 using system 12 is a takeaway service. In some embodiments wherein the defined event is a proximity event, the service obtained from hospitality vendor 2 using system 10 is a dine-in service.

In embodiments wherein the defined event(s) is a duration event, typically, the service obtained by customer 1 and consumer 3 from vendor 2 using system 12 is a takeaway service. In some embodiments wherein the defined event is a proximity event, the service obtained from hospitality vendor 2 using system 10 is a dine-in service.

In typical embodiments wherein service obtained by customer 1 and consumer 3 from vendor 2 using system 12 is a dine-in service, when the submitted pre-order is received by vendor 2, vendor 2 arranges to seat customer 1 and consumer 3 and/or commences preparation of food and/or beverages for customer 1 and consumer 3.

In typical embodiments wherein service obtained by customer 1 and consumer 3 from vendor 2 is a takeaway service, when the submitted pre-order is received by vendor 2, vendor 2 commences preparation of food and/or beverages for customer 1 and consumer 3 and/or arranges to monitor for arrival of customer 1 and consumer 3.

In some typical embodiments, systems 10, 11, and 12 can communicate information relating to customer 1 and/or consumer 3 to vendor 2.

In some embodiments of systems 10, 11, and 12, in use, customer computing device 100 and customer application 51 communicates information relating to customer 1 to vendor computing device 200, for review by vendor 2 using computing device 200 and vendor application 52.

In some embodiments of system 11, in use, customer computing device 100 and customer application 51 or consumer computing device 300 and consumer application 53 communicates information relating to consumer 3 to computing device 200, for review by vendor 2 using computing device 200 and vendor application 52.

In some embodiments of systems 12, in use, customer computing device 100 and customer application 51, or consumer computing device 300 and consumer application 53, communicates information relating to customer 1 and/or consumer 3 to computing device 200, for review by vendor 2 using computing device 200 and vendor application 52.

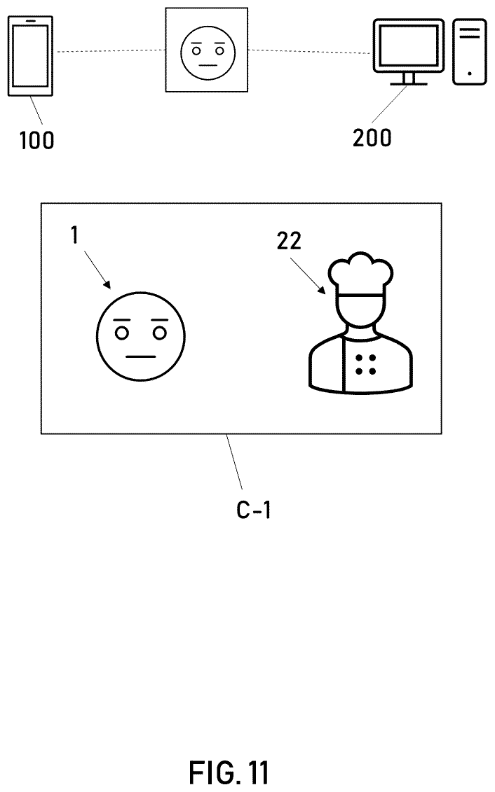

In some embodiments, the information relating to customer 1 and/or consumer 3 communicated to vendor 2 includes identification information. Typically, the identification information, such as an image of customer 1 and/or consumer 3, is for allowing vendor 2 to identify customer 2 and/or consumer 3 at a location of vendor 2. A schematic illustration of communication of identification information for customer 1 from customer computing device 100 to vendor computing device 200 allowing identification of customer 1 by an employee 22 of vendor 2 is shown in FIG. 11.

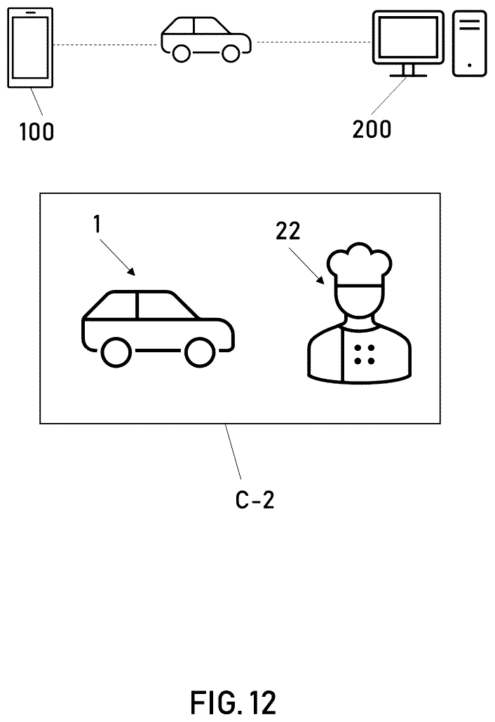

In some embodiments, the information relating to customer 1 and/or consumer 3 communicated to vendor 2 includes transportation information. Typically, the transportation information, such as a registration number of a vehicle transporting customer 1 and/or consumer 3, is for allowing vendor 2 to monitor for arrival of customer 2 and/or consumer 3 at a location of vendor 2. A schematic illustration of communication of transportation information for customer 1 from customer computing device 100 to vendor computing device 200 allowing employee 22 of vendor 2 to monitor for arrival of customer 1 is shown in FIG. 12.

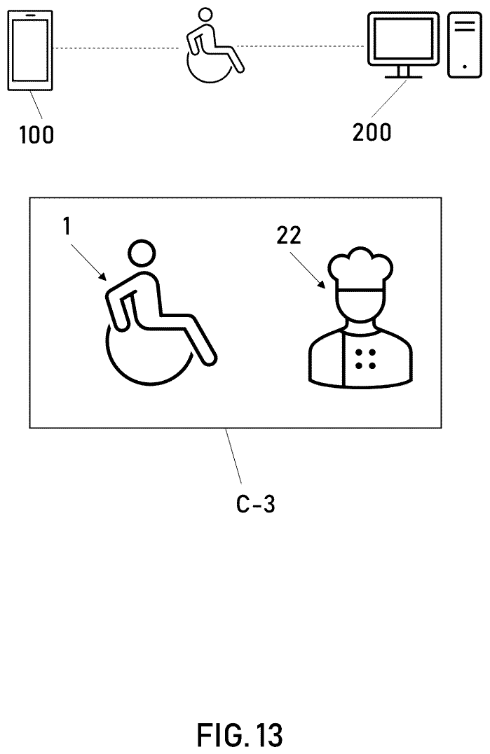

In some embodiments, the information relating to customer 1 and/or consumer 3 communicated to vendor 2 includes accessibility information. Typically, the accessibility information, such as a requirement for a wheelchair ramp, is for allowing vendor 2 to organise meeting accessibility requirements of customer 1 and/or consumer 3 upon arrival of customer 1 and/or consumer 3 at a location of vendor 2. A schematic illustration of communication of accessibility information for customer 1 from customer computing device 100 to vendor computing device 200 allowing employee 22 of vendor 2 to be prepared to meet an accessibility requirement of customer 2 is shown in FIG. 13.

In some typical embodiments, in use, systems 10, 11, and 12 can present information relating to a plurality of vendors.

In some embodiments of systems 10, 11, and 12, in use, customer computing device 100 and customer application 51 presents information relating to a plurality of vendors to customer 1. In use, customer 1 may use the information presented to identify a suitable vendor 2 with which to place a pre-order.

In some embodiments of system 11 and 12, in use, consumer computing device 300 and consumer application 53 presents information relating to a plurality of vendors to consumer 3. In use, consumer 53 may use the information presented to modify a pre-order placed by customer 1.

The information relating to the plurality of vendors may include proximity information.

In some embodiments of systems 10, 11, and 12, the proximity information includes proximity of a location of each of the plurality of vendors from a location of customer computing device 100.

In some embodiments of system 11 and system 12, the proximity information includes proximity of a location of each of the plurality of vendors from a location of consumer computing device 300.

The information relating to the plurality of vendors may include duration information.

In some embodiments of systems 10, 11, and 12, the duration information includes estimated duration until customer computing device 100 is present at a location of each of the plurality of vendors.

In some embodiments of system 11 and system 12, the duration information includes estimated duration until consumer computing device 300 is present at a location of each the plurality of vendors.

The information relating to the plurality of vendors may include availability information.

In some embodiments of systems 10, 11, and 12, the availability information includes information on availability of one or more goods or services of interest to customer 1 from each of the plurality of vendors.

In some embodiments of system 11 and system 12, the availability information includes information on availability of one or more goods or services of interest to the consumer 3 from each of the plurality of vendors.

The information relating to the plurality of vendors may include accessibility information.

In some embodiments of systems 10, 11, and 12, the accessibility information includes information on whether each of the plurality of vendors can accommodate an accessibility need of customer 1.

In some embodiments of system 11 and system 12, the accessibility information includes information on whether each of the plurality of vendors can accommodate an accessibility need of consumer 3.

### EXAMPLE

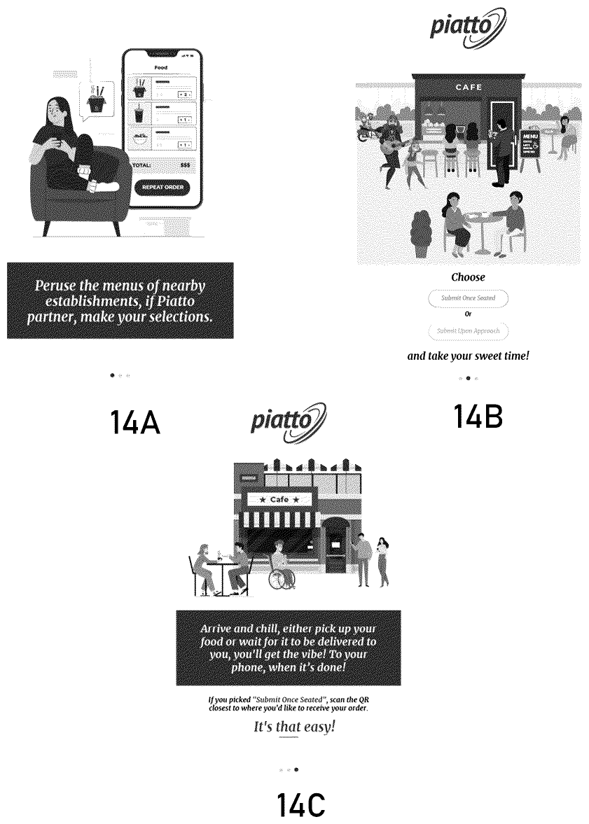

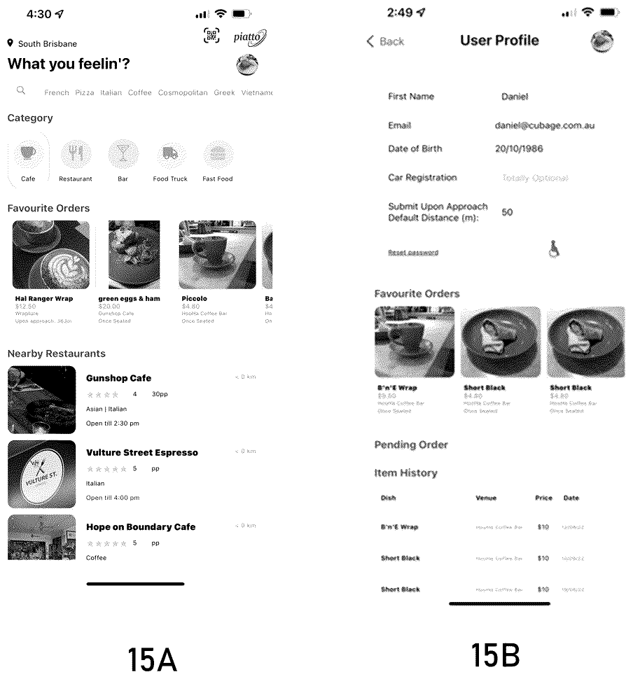

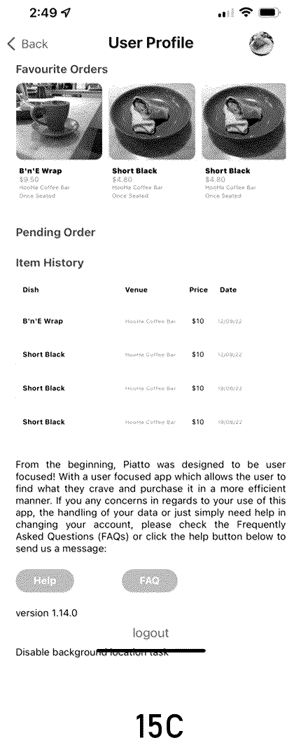

With reference to FIG. 14 and FIG. 15, a typical embodiment of a computer program according to an aspect of the invention is described in this example, which will be referred to henceforth as the ‘Piatto’ application.

Piatto was coded using the React Native framework, JavaScript and TypeScript, compiled using Apple Xcode and Google's Android Studio. The internet software application was coded using the React.js framework, JavaScript and TypeScript. The database facilitating storage of data used across the mobile and internet software applications is Firebase as maintained by Google, stored remotely and securely by Google in cloud storage.

A series of introductory screens for Piatto are presented in FIG. 14. These screens provide a brief introduction to functionality of the Piatto application.

With reference to FIG. 15A, the default Piatto home screen allows a user to select from a horizontally scrolling list of cuisine styles, seven of which are visible upon first instance of the screen loading on an Apple iPhone 13 Pro Max. Categories of vendors are also horizontally listed and selectable. ‘Favourite Orders’, for the user are presented below a ‘Category’ list, also with horizontal scroll capability. Below ‘Favourite Orders’, is a list of ‘Nearby Restaurants’, listed in order of proximity based on the GPS data of the user device.

With reference to FIG. 15B, a ‘User Profile’ screen allows for user details, including ‘Profile Picture’, ‘Name’, ‘Email’, ‘Date of Birth’, ‘Vehicle Registration’, and ‘Accessibility Requirements’ to be entered and edited. A ‘Submit Upon Approach Default Distance’ field allows the user to change the default distance that is used for a ‘Submit Upon Approach’ option when that option is selected.

With reference to FIG. 15C, a ‘Pending Order’ field of the ‘User Profile’ screen shows orders that have been processed on the device but not yet submitted to the venue (blank in the case of FIG. 15C). Any order shown could be, for example, because the device has not yet reached the selected proximity distance or, if ‘Submit Once Seated’ has been selected, an applicable QR code has not yet been scanned. In the instance that an order processed under the condition of ‘Submit Once Seated’ was still residing in the device memory and not yet submitted to the venue, the QR icon on the top right of the home screen, would be illuminated red, to signify that the application is waiting for a QR code to be scanned. The ‘Item History’ is a list of all previously ordered items by the user.

It will be readily appreciated that the ‘Submit Upon Approach’ functionality in the context of the Piatto application is one non-limiting example corresponding to the proximity event functionality as hereinabove described in detail.

It will be readily appreciated that the ‘Submit Once Seated’ functionality in the context of the Piatto application is one non-limiting example corresponding to the code event functionality as hereinabove described in detail.

It will be understood that the Piatto application may incorporate various other features or functionality beyond that specifically described above in this example. Without limitation, iterations of the Piatto application may incorporate one or more of online shopping functionality; targeted advertising functionality; gambling functionality; rewards system functionality; and cryptocurrency functionality.

It will be understood generally that the description of embodiments of the invention as provided herein is for purposes of description to one of ordinary skill in the related art. It is not intended to be exhaustive or to limit the invention to a single disclosed embodiment. In some instances, well-known components and/or processes have not been described in detail, so as not to obscure the embodiments described herein. In particular, detailed discussion of well-known internet functionality and the role of various forms of servers and the like in mediating communication between devices has not been discussed, as this will be readily and fully understood by the skilled person.

Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations that have been discussed herein, and other embodiments that fall within the spirit and scope of the invention.

By way of non-limiting example, it is noted that selection, adjustment, and customisation of the event in response to which the pre-order is submitted to the vendor has been primarily discussed in relation to selection, adjustment, and/or customisation by the customer and/or consumer. While event selection, adjustment, and/or customisation by the customer and/or consumer is indeed typical, it will be appreciated that event selection, adjustment, and/or customisation by the vendor is also possible and such an option may be desirable in some circumstances. For example, it may be desirable to allow the vendor ability to set or adjust a value, or minimum value, for the proximity or duration event as herein described, in order to allow sufficient time for the vendor to prepare goods, such as food and/or beverages, prior to arrival of the customer and/or consumer.

It is further noted that transmission of particular types of information relating to a customer and/or consumer to a vendor, and presentation of certain particular types of information on one or more vendors to a customer and/or consumer has been described herein, in the context of systems and methods of the invention. It will be appreciated that it may be desirable, in some circumstances, to transmit and/or present various other types of information. By way of non-limiting example, disease control requirements have been primarily discussed herein in respect of transmission of information relating to a customer and/or consumer to a vendor, however it may additionally or alternatively be desirable to facilitate presentation of information on disease control requirements of one or more vendors to a customer and/or consumer. It will be appreciated that disease control requirements of a vendor presented to a customer and/or consumer may include a requirement for particular PPE, a requirement to maintain a particular distance from vendor staff, a requirement for particular vaccination status, and/or a requirement for a negative disease test result, although without limitation thereto.

It is further noted that, while transmission of information relating to a customer and/or consumer to a vendor has primarily been discussed herein as occurring substantially concurrently with submission of an order for a vendor in response to an event, this need not necessarily be the case. It may be desirable, in some circumstances, to transmit information relating to a customer and/or consumer to a vendor substantially prior to submission of an order for the vendor. By way of non-limiting example, it may be desirable to transmit accessibility information relating to a customer and/or consumer to a vendor substantially prior to submission of an order for the vendor, to allow additional time for the vendor to make arrangements to accommodate accessibility needs of the customer and/or consumer (e.g. ramps; seating location and/or configuration).

It will be understood that, in some embodiments, information relating to a customer and/or consumer may be submitted to a vendor in response to a proximity event or a duration event as hereinabove described in the context of submission of an order for a vendor, wherein the proximity event or duration event is a prior proximity event or duration event occurring before the event in response to which the order for the vendor is submitted. By way of non-limiting example, information relating to a customer and/or consumer may be transmitted to a vendor in response to a prior proximity event or prior duration event, such that the information is transmitted to the vendor about 5, 10, 15, 20, 25, 30, 35, 40, 45, 50 or 55 minutes prior to submission of the order for the vendor, or about 1, 2, 3, 4, 5, 6, 7, 8, 9, 10, 11, or 12 hours prior to submission of the order for the vendor.

It will be further understood that, although systems and methods have been described herein have focused on a single customer and/or consumer for illustrative purposes, this is non-limiting. By way of example, it will be understood that system 11 as described herein could be used for ordering by a customer on behalf of a plurality of consumers, such as in the context of a personal assistant arranging for dining of a party of consumers.

Accordingly, it will be further understood that submission of an order in response to one or more events, as herein described in the context of embodiments of methods and systems of the invention wherein a customer and a consumer together obtain a good and/or service from a vendor, could similarly apply in the context of embodiments of methods and systems of the invention wherein a plurality of consumers together obtain a good and/or service from a vendor. As an example, an order may be submitted to a vendor in response to a plurality of code scanning events performed or completed by a plurality of consumers. As another example, an order may be submitted to a vendor in response to a proximity event and/or duration event involving a plurality of consumers.

With reference to systems 10-12, exemplary defined events and exemplary triggering of submission of orders to vendor 2 have been described. However, the skilled person will readily appreciate that a range of variations could be made to the particular examples set out herein.

It is noted, for example, that various combinations of code scanning, proximity, and/or duration events as herein described could be combined, the events performed or completed by one or more, or a plurality, of customers and/or consumers. By way of non-limiting example, it may be desirable in some instances to arrange for a pre-order to be submitted a defined duration after a defined proximity requirement is met. It may be desirable in some instance to arrange for a pre-order to be submitted a defined duration after a defined code scanning requirement is met.

It will be further appreciated that, although not typical, proximity and/or duration events may be arranged to trigger an order upon arrival at a venue. That is, a proximity or duration value of zero or substantially zero distance or time units, respectively, could be selected to trigger an order upon arrival.

It will be appreciated that the defined events described with reference to systems 10-12, including proximity events, duration events, and code scanning events, are events that include a substantially separate or distinct action or step from the pre-ordering step.

Although typical forms of the invention involve an event that includes a substantially separate or distinct action or step from the pre-ordering step, as hereinabove described, alternative forms of the invention may instead involve a “simple event”. It will be understood that, in this specification, the terms “simple event” and “simple events”, and the like, are used to distinguish events triggering pre-order submission of alternative forms of the invention from those of typical forms of the invention, such as code scanning, proximity, or duration events, that include a substantially separate or distinct action or step from the preparation of the pre-order for the vendor.

As used herein, “simple events” will be understood to exclude, at a minimum, code scanning, proximity, and duration events as described herein. Typically, simple events include events performed with the same computing device and/or the same software application to concurrently, or substantially concurrently, perform the event and submit the pre-order, such as reservation events as hereinabove described.

As hereinabove described, simple events that are reservation events typically involve entry and/or submission of a date and/or time requirement for fulfilment of the order by the vendor. The date and/or time requirement may be any suitable date and/or time requirement. In embodiments, the date requirement is for a date between 1 and 7 days from the reservation event, including about 2, 3, 4, 5, and 6 days from the reservation event. In embodiments, the date requirement is for a date between about 1 and about 8 weeks from the reservation event, including about 2, 3, 4, 5, 6, and 7 weeks from the reservation event. In embodiments, the date requirement is for a date between about 1 and about 12 months from the reservation event, including about 2, 3, 4, 5, 6, 7, 8, 9, 10, and 11 months from the reservation event.

It will be further understood that aspects or embodiments of the invention as described herein may include an “override event”.

As used herein, the terms “override event” and “override events” and the like will be understood to refer to an action in response to which the pre-order is immediately or substantially immediately submitted to the vendor in the context of methods and systems as described herein. Override events may be performed with the same computing device and/or the same software application as was used to prepare the pre-order, such as the customer computing device and/or customer application. Override events may be performed with a different computing device and/or a different software application as was used to prepare the pre-order, such as the consumer computing device and/or consumer application or the vendor computing device and/or vendor application.

At least certain embodiments of systems and methods of the invention may have particular advantages or benefits. Non-limiting discussion of certain advantages follows. Advantages will be discussed primarily in the context of ordering of food and/or beverages, however it will be appreciated that at least some of the discussed advantages may be more broadly applicable.

Advantageously, at least certain typical systems and methods of the invention can allow for pre-ordering from a vendor, wherein the order is not submitted until submission is triggered by an event, such as a confirmation event, a proximity event, or a duration event.

Pre-ordering followed by submission triggered by an event, such as a confirmation event, a proximity event, or a duration event, using systems or methods of the invention can provide advantages in terms of convenience. A customer can perform pre-ordering at a convenient time and/or location, avoiding the need for ordering to be performed by the customer upon arrival at a vendor location.

Pre-ordering followed by submission triggered by an event, such as a confirmation event, a proximity event, or a duration event, using systems or methods of the invention can provide advantages in terms of hygiene and/or disease control. Pre-ordering of food and/or beverages using the system or method can discourage contact with mobile devices directly prior to contact the food and/or beverages.

Pre-ordering followed by submission triggered by an event, such as a code event, a proximity event, or a duration event, using systems or methods of the invention can provide advantages in terms of product freshness. Submission of an order for food and/or beverages when triggered by the defined event using the system or method can help ensure that a customer or consumer is available to receive the food and/or beverage(s) when the food and/or beverage(s) have been freshly prepared.

Advantageously, at least certain typical systems and methods of the invention can allow for communication of information relating to the customer and/or consumer to the vendor, such as identification information, party size information, disease control information, and/or accessibility information.

Advantageously, communication of identification information to the vendor can facilitate identification of the customer and/or consumer upon arrival to or near to the vendor. This can allow the vendor to efficiently service the customer and/or consumer.

Advantageously, communication of party size information to the vendor can allow the vendor to plan for an expected party size. This can allow the vendor to efficiently accommodate the party including the customer and/or consumer.

Advantageously, communication of disease control information to the vendor can alert the vendor to particular disease control requirements applicable to the customer and/or consumer. This can allow the vendor to take adequate steps to minimise disease risk associated with the servicing of the customer and/or consumer.

It will be appreciated that communication of household number and/or household size information on the customer and/or consumer could be performed in the context of communication of party size and/or disease control information to the vendor. In some contexts, such as disease control contexts, it may be advantageous to provide information allowing a vendor to seat members of a given household or households in specific configurations, such as to maintain members of a given household together and/or to maintain minimum distance between households.

Advantageously, communication of accessibility information to the vendor can alert the vendor to particular accessibility requirements applicable to the customer and/or consumer. This can allow the vendor to take adequate steps to accommodate the accessibility requirements of the customer and/or consumer.

Advantageously, at least certain typical systems and methods of the invention can allow for presentation of information to the customer and/or consumer relating to a plurality vendors, such as proximity information, duration information, operating information, availability information, or accessibility information, prior to preparation of the order for the vendor.

Advantageously, presentation of proximity information to the customer and/or consumer can allow for proximity of the respective vendors to be considered when selecting a vendor with which to place an order.

Advantageously, presentation of duration information to the customer and/or consumer can allow for travel duration until arrival at the respective vendors to be considered when selecting a vendor with which to place an order.

Advantageously, presentation of operating information to the customer and/or consumer can allow for hours or operation and/or or current open or closed status to be considered when selecting a vendor with which to place an order.

Advantageously, presentation of availability information to the customer and/or consumer can allow for availability of a particular product or service to be considered when selecting a vendor with which to place an order.

Advantageously, presentation of accessibility information to the customer and/or consumer can allow for capacity to meet accessibility requirements to be considered when selecting a vendor with which to place an order.

In this specification, use of the terms “suitable” and “suitably”, and similar terms, is not to be read as implying that a feature or step is essential, although such features or steps may well be preferred.

In this specification, the indefinite articles “a” and “an” are not to be read as singular indefinite articles or as otherwise excluding more than one or more than a single subject to which the indefinite article refers. For example, “a” device includes one device, one or more devices, and a plurality of devices.

In this specification, the terms “comprises”, “comprising”, “includes”, “including”, and similar terms, are intended to denote the presence of a stated integer or integers, but not necessarily the exclusion of another integer or other integers, depending on context. That is, a device, system, or method, etc., that comprises or includes stated integer(s) need not have those integer(s) solely, and may well have at least some other integers not stated, depending on context.

In this specification, the terms “consisting essentially of” and “consists essentially of” are intended to mean a non-exclusive inclusion only to the extent that, if additional elements are included beyond those elements recited, the additional elements do not materially alter basic and novel characteristics. That is, a device, system, or method that “consists essentially of” one or more recited elements includes those elements only, or those elements and any additional elements that do not materially alter the basic and novel characteristics of the device, system, or method.

In this specification, terms such as “above” and “below”; “front” and “back”; “top” and “bottom”; “left” and “right”; “horizontal” and “vertical”, and the like, may be used for descriptive purposes. However, it will be understood that embodiments can potentially be arranged in various orientations, and that such relative terms are not limiting and may be interchangeable in appropriate circumstances.

In this specification, unless the context requires otherwise, the terms “connection”, “connected”, “connecting”, and the like, are not to be read as limited to direct connections and may also include indirect connections. For example, unless the context requires otherwise, a stated first component “connected” to a stated second component may be connected via, through, or by, one or more unstated components.

1. A method for pre-arranged ordering from a vendor, the method including steps of (a) preparing an order for a vendor; and (b) submitting the order to the vendor in response to an event, wherein the event is selected from a confirmation event, a proximity event, and a duration event.

2.-28. (canceled)
